(19) United States
(12) Patent Application Publication
(10) Pub. No.: US 2008/0034900 A1
(43) Pub. Date: Feb. 14, 2008

(54) APPARATUS AND METHOD TO SAMPLE A MATERIAL FOR LATER ANALYSIS

(76) Inventor: David S. Bollinger, Grapevine, TX (US)

Correspondence Address: Brandon S. Clark, Suite 1800, 2700 Post Oak Blvd., Houston, TX, 77056, US

(21) Appl. No.: 11/755,908

(22) Filed: May 31, 2007

Related U.S. Application Data
(60) Provisional application No. 60/836,560, filed on Aug. 9, 2006.

(51) Int. Cl. G01N 1/14

(52) U.S. Cl. 73/864.73

(57) ABSTRACT

Methods and apparatus for obtaining a liquid material for an analysis. Provided are a sample container, a sample tube, a vacuum tube, and a vacuum generator. The sample tube forms a fluid path between the liquid to be sampled and the storage container. The vacuum tube forms a fluid path between the sample container and the vacuum generator. The vacuum generator creates a partial vacuum, or suction, which draws liquid material through the sample tube and into the sample container.

### CROSS REFERENCE TO RELATED APPLICATIONS

This application claims priority to U.S. provisional application Ser. No. 60/836,560, filed on Aug. 9, 2006 and incorporated herein by reference.

### BACKGROUND OF THE INVENTION

1. Field of the Invention

This invention generally relates to sampling of materials and, in particular, to an apparatus and method for sampling materials, such as fluids, commonly used in various semiconductor manufacturing processes.

2. Description of the Related Art

Modern-day industry, particularly the semiconductor industry, uses many chemical solutions, baths, and other such fluids in producing their products. Some of these fluids have particular properties that degrade over time. Others are used during multiple cycles of a manufacturing process, resulting in contamination of the fluids. Rather than merely disposing a fluid that may or may not have reached its useful life, it is often more desirable to test the fluid to determine its state. It is also useful to test fluids used in processes to determine if the process is causing or contributing contamination to the produced product. In such situations, a portion of the fluid, often referred to as a sample, is taken from the larger body of fluid in question. Such sampling, however, presents several problems to be overcome.

Samples are often obtained by retrieving the portion of fluid to be tested with an implement and then pouring the portion into a sample container. Such practice may lead to spills that may be dangerous if the fluid is a hazardous material, especially if the sample container is rinsed with the fluid. Further, the sample may become inadvertently contaminated, as it is being transferred to the sample container, for example, by foreign matter in the air, on the hands or gloves of the person obtaining the sample, or on the implement being used to retrieve the sample. Such contamination may cause tests performed on the sample to produce results that erroneously reflect the condition of the fluid being tested.

Another method of obtaining a sample is to use a flexible sample container and a flexible tube, where the flexible sample container is compressed or squeezed to create a suction which draws a fluid sample through the tube and into the bottle. Here, the sample container is used to both generate the suction and to store the fluid sample. Such a practice may lead to contamination of the sample, as deforming the sample container may cause cracks or fractures to develop on the interior surfaces of the sample container. These cracks could then hold impurities and contribute contamination to the sample stored within the sample container.

It may be desirable to only sample a small portion of the fluid in question and in such situations it may be further desirable to contain the sample in a small vessel to minimize packaging. Small sample volumes may also be advantageous in that fewer shipping restrictions may be imposed on the sample. Small sample containers or vessels are generally difficult to fill because of their size and the risk of spilling the sample while filling the container.

Therefore, a method and apparatus is needed to obtain samples of fluids.

### SUMMARY OF THE INVENTION

In one embodiment of the present invention, a material sampling apparatus is provided, which includes:
a sample storage container;
a sample tube, wherein the sample tube defines a fluid path between a liquid material to be sampled and the sample storage container;
a vacuum tube; and
a vacuum generator suitable for generating a partial vacuum, wherein:
   the vacuum tube defines a fluid path between the sample storage container and the vacuum generator; and
   the partial vacuum generated by the vacuum generator is suitable for drawing part of the liquid material to be sampled through the sample tube and into the sample storage container, thereby filling the sample storage container with liquid material to a predetermined level.

In another embodiment of the present invention, a material sampling apparatus is provided, which includes:
a sample storage container;
a sample tube, wherein the sample tube defines a fluid path between a liquid material to be sampled and the sample storage container;
a vacuum tube; and
a corrugated type flexible bottle, which is suitable for generating a partial vacuum, wherein:
   the partial vacuum is generated by applying an external force to the bottle, which deforms the flexible bottle thereby reducing its internal volume, and then removing the external force which allows the flexible bottle to return to its original shape;
   the vacuum tube defines a fluid path between the sample storage container and the flexible bottle; and
   the partial vacuum generated by the flexible bottle is suitable for drawing part of the liquid material to be sampled through the sample tube and into the sample storage container, thereby filling the sample storage container with about 30 ml of the liquid material
an outer casing, wherein:
   the outer casing is detachably connected to the flexible bottle and the sample storage container by threaded type connections; and
   the outer casing encloses at least part of the sample tube.

In yet another embodiment of the present invention, a method of sampling a material is provide, which includes:
providing a sampling device, wherein the sampling device comprises a a sample storage container;
   a sample tube, wherein the sample tube defines a fluid path between a liquid material to be sampled and the sample storage container;
   a vacuum tube;
   a flexible bottle, wherein the vacuum tube defines a fluid path between the sample storage container and the flexible bottle; and
   an outer casing which comprises detachable connections to the flexible bottle and the sample bottle, and which encloses at least part of the sample tube;
applying a force to the flexible bottle which deforms the flexible bottle thereby decreasing its inner volume;
placing an end of the sample tube into the liquid material to be sampled;
removing the force from the flexible bottle, thereby allowing the bottle to return to its initial shape and generating a partial vacuum; and
drawing a sample, with the partial vacuum, through the sample tube and into the sample storage container, wherein the sample comprises less than about 30 ml of the liquid material.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic illustration of an apparatus for obtaining a liquid sample, according to one embodiment of the current invention;

FIG. 2 is a schematic illustration of an apparatus for obtaining a liquid sample, according to another embodiment of the current invention; and

FIG. 3 is a flow diagram for a method of obtaining a liquid sample with an apparatus such as the one depicted in FIG. 1, according to another embodiment of the current invention.

### DETAILED DESCRIPTION OF PREFERRED EMBODIMENTS

Illustrative embodiments of the invention are described below. It will of course be appreciated that in the development of any such actual embodiment, numerous implementation-specific decisions may be made to achieve the developer's specific goals, such as compliance with system-related and business-related constraints, which will vary from one implementation to another. Also, it should be noted that embodiments of the present invention described herein may be operated in conjunction with other systems or independently of such systems. The present invention should not be limited to the systems, or portions thereof, described herein and persons of ordinary skill in the art will appreciate that the present invention may be used to obtain liquid samples for applications other than those described herein (e.g., pharmaceutical applications, food processing applications, etc.).

Certain terms are used throughout the following description, and claims refer to particular components. This document does not intend to distinguish between components that differ in name but not function. Likewise, in the following discussion and the claims the terms “including” and “comprising” are used in open-ended fashion and thus should be interpreted to mean “including, but not limited to . . . ”

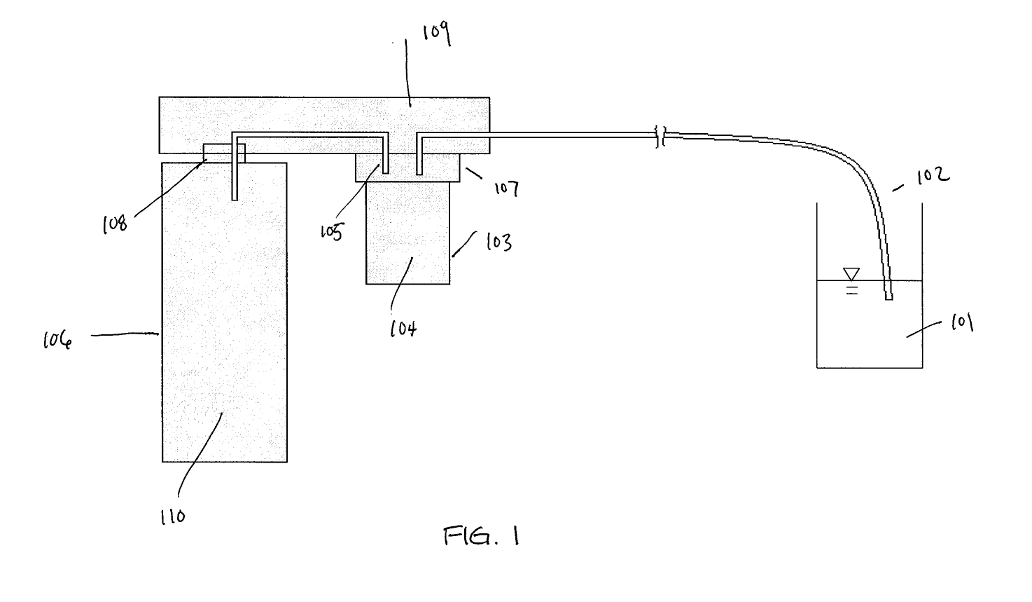

In one embodiment of the invention, an apparatus 100 for collecting a liquid sample, such as that shown in FIG. 1, may be provided. The apparatus 100, also referred to herein as a sampler, is suitable for collecting a wide variety of liquid samples 101. In one embodiment, the sampler 100 is used for collecting samples of liquids used in semiconductor manufacturing processes. For instance, some examples of liquids used in semiconductor manufacturing processes, and which may be collected by the sampler, can include: deionized water, hydrofluoric acid, hydrogen peroxide, ammonium hydroxide, hydrochloric acid, isopropyl alcohol, and nitric acid.

The sampler 100 has a sample tube 102, one end of which interfaces with the liquid sample 101 to be collected. Commonly this interface may be achieved by placing one end of the sample tube into the liquid sample such that a free end of the tube 102 is submerged in the liquid 101. The other end of the sample tube 102 interfaces with a sample storage container 103. In certain embodiments, the tube 102 may have a variable length, and be made from a chemically inert material. In a particular embodiment the tube 102 is made of ⅛″-¼″ diameter plastic tubing.

The sample tube 102 creates a fluid path between the liquid sample 101 and the sample storage container 103. The sample storage container 103 stores the liquid sample 101 which is collected, and may be sized such that its interior volume 104 is suitable for storing at least a predetermined amount of the liquid sample 101. In some embodiments, the interior volume 104 may be sized such that it contains about 30 ml or less of liquid sample 101, and the sample container may be made of a chemically inert material. A sample container which contains 30 ml or less of liquid sample may be advantageous in that it can be difficult or costly to transport liquid samples exceeding 30 ml in volume due to government regulations and/or safety requirements.

Also interfacing with the sample storage container 103 is one end of a vacuum tube 105. The other end of the vacuum tube 105 interfaces with a vacuum generator 106, with the vacuum tube 105 thereby creating a fluid path between the vacuum generator 106 and the sample container 103. In certain embodiments, the vacuum tube 105 may have a variable length, and be made from chemically inert material. In other embodiments the vacuum tube 105 is made of ⅛″-¼″ diameter plastic tubing.

The vacuum generator 106 is suitable for generating a partial vacuum. As the vacuum generator 106 is in fluid communication with the liquid sample 101 (via the vacuum tube 105, the sample container 103, and the sample tube 102) the partial vacuum generated by the vacuum generator 106 is suitable to draw part of the liquid sample 101 through the sample tube 102 and into the sample container 103. In some embodiments, the partial vacuum draws about 30 ml of the liquid sample 101 into the sample container 103.

In some embodiments the vacuum generator 106 is a flexible bottle made of a chemically inert material. In these embodiments, the flexible bottle can be of any shape desired, including cylindrical, bulbous, spherical, etc, shapes. Also in these embodiments, the partial vacuum is generated when first an external force is applied to the flexible bottle 106, which causes it to slightly deform, thereby decreasing the interior volume 110 of the flexible bottle 106. The external force may be applied to any location, or more than one location, on the flexible bottle (e.g. bottom, sides, etc). In a particular embodiment, the external force is applied by a human user's hand. The flexible bottle may be treated suitably to allow the bottle to be gripped by the user's hand. Such treatments could include indentations, roughened surfaces, patterned surfaces or other treatments as known in the art. When the external force is removed, the flexible bottle returns to substantially its original shape and a partial vacuum, or suction type force, is thus created. In some embodiments, the flexible bottle 106 may have an interior volume 110, in the original, undeformed state, of about 100 ml to about 500 ml.

In one embodiment, a user may determine the amount of external force necessary to apply to the flexible bottle 106 in order to draw 30 ml or less of liquid sample 101 into the sample container 103. In another embodiment, the flexible bottle 106 may be sized such that its deformation will cause only about 30 ml or less of liquid sample 101 to be drawn into the sample container 103. In some embodiments, the length of the sample tube 102 and the vacuum tube 105 are such that when they are disposed into the sample container 103 which contains about 30 ml or less of liquid sample 101, neither the sample tube 102 nor the vacuum tube 105 is in contact with, or submerged in, the liquid sample 101.

In some embodiments of a sampler, according to the current invention, an outer casing 109 may be provided. In these embodiments, the outer casing 109 encloses at least part of the sample tube 102, and provides detachable connections 107, 108 for the sample container 103 and the vacuum generator 106. The detachable connections 107, 108 may be threaded type connections, quick-disconnect couplings or other detachable type connections as known in the art.

It has been described above that in some embodiments the sample tube 102, the sample container 103, the vacuum generator 106, and the vacuum tube 105 are made of a chemically inert material. This chemically inert material helps to minimize the possibility of contamination in the collected sample and may be a material selected from polymers such as HDPE, PFA, FEP, polyethylene, or other known chemically inert materials.

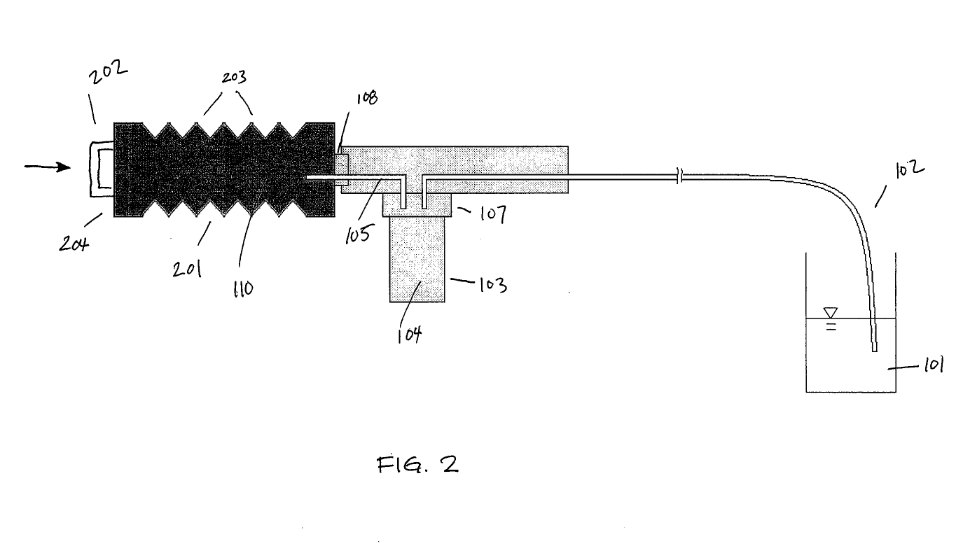

FIG. 2 shows a particular embodiment of a sampler 200 according to the current invention, where the vacuum generator is a corrugated type flexible bottle 201. Components which were previously described above with respect to FIG. 1 are identified by like numerals. The corrugations 203 of flexible bottle 201 allow for an efficient generation of the partial vacuum by allowing an easier deformation of the flexible bottle's 201 interior volume in response to an external force applied to an end 204 of the bottle 201. In FIG. 2, the external force is indicated by a directional arrow. In some embodiments, a handle 202 is also provided to aid in the application of the external force to the flexible bottle 201. This handle 202 is properly sized to accommodate a human hand. In other embodiments, the corrugated type flexible bottle 201 may have an interior volume 204, in the original, undeformed state, of about 100 to about 500 ml.

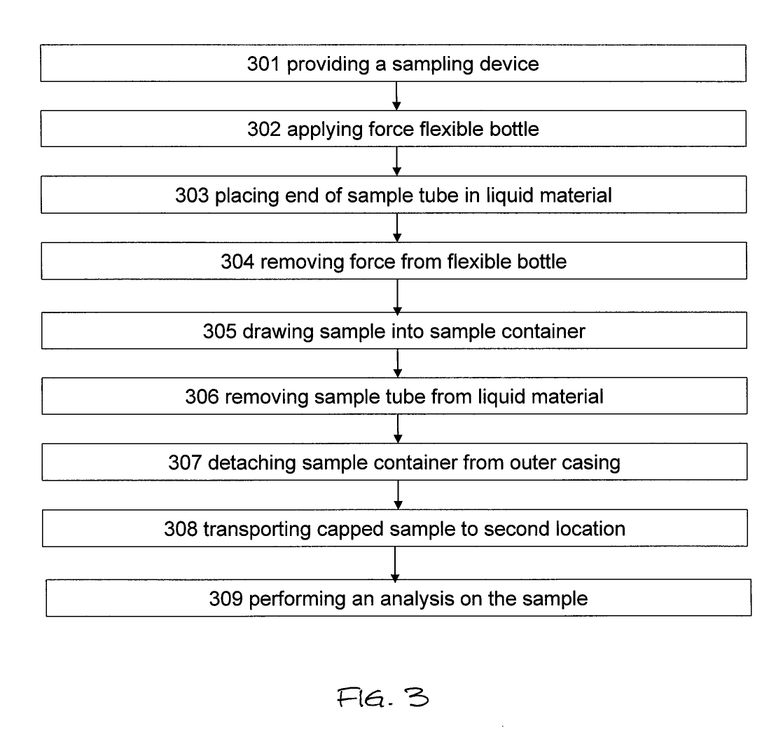

FIG. 3 shows a flow diagram depicting the steps of one embodiment of a method 300, according to the current invention, for obtaining a liquid sample. For ease of discussion, the following description of the method refers to the same reference numbers used to describe the embodiments of the apparatus 100 disclosed above. However, it will be appreciated that the method is similarly applicable to the apparatus 200 shown in FIG. 2.

In the first step 301, a sampler 100 is provided. An external force is applied to the flexible bottle 106a of the sampler 100 in the second step 302. This external force causes the flexible bottle 106a to slightly deform, thereby decreasing the interior volume 110 of the flexible bottle 106a. In the third step 303, one end of the sample tube 102 is placed into the liquid material 101. Then in fourth step 304, the external force is removed from the flexible bottle 106a, which thereby generates a partial vacuum, or suction type force, when the flexible bottle 106a returns to substantially its original, undeformed state. This partial vacuum, or suction type force, is then transmitted through the vacuum tube 105, the sample container 103, and the sample tube 102. In the fifth step 305 the partial vacuum then draws part of the liquid 101 through the sample tube 102 and into the sample container 103. In one embodiment, the amount of liquid 101 drawn into the sample container 103 in this step will be about 30 ml or less. The sample tube 102 is removed from the liquid material in the sixth step 306, and in the seventh step 307, the sample container 103 is removed from the outer casing 109. Advantageously, the sample container 103 is connected to the outer casing 109 by a detachable type connection 107, such as a threaded connection, which allows for ease of removal. After the sample container 103 is removed, it may be capped closed or covered so that the sample contained therein is protected from contamination and also so it cannot spill out of the capped sample container. In the eighth step 308, the capped sample container may be transported to a location separate from that where the sample was obtained. Finally, in the ninth step 309, an analysis may be performed on the sample.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An apparatus for obtaining a liquid material sample comprising:
a) a sample storage container;
b) a sample tube, wherein the sample tube defines a fluid path between a liquid material to be sampled and the sample storage container;
c) a vacuum tube in fluid communication with the sample storage container; and
d) a vacuum generator suitable for generating a partial vacuum, wherein:
1) the vacuum tube defines a fluid path between the sample storage container and the vacuum generator; and
2) the partial vacuum generated by the vacuum generator is suitable for drawing part of the liquid material to be sampled through the sample tube and into the sample storage container, thereby filling the sample storage container with liquid material to a predetermined level.

2. The apparatus of claim 1, wherein the vacuum generator comprises a flexible bottle having an undeformed shape and a deformed shape, the flexible bottle being deformable from the undeformed shape to the deformed shape by application of an external force to the flexible bottle, and wherein the flexible bottle has a propensity to return to the undeformed shape upon removal of the external force, thereby creating the partial vacuum.

3. The apparatus of claim 2, wherein the flexible bottle has an internal volume, in the undeformed shape, of between about 100 ml and about 500 ml.

4. The apparatus of claim 2, wherein the flexible bottle is a corrugated type flexible bottle.

5. The apparatus of claim 2, wherein the flexible bottle further comprises a handle suitable to assist in the application of the external force, the handle being sized to accommodate a human hand.

6. The apparatus of claim 1, further comprising an outer casing which comprises detachable connections to the vacuum generator and the sample container, and which encloses at least part of the sample tube.

7. The apparatus of claim 6, wherein the connections between the outer casing, the vacuum generator, and the sample bottle are threaded connections.

8. The apparatus of claim 6, wherein the connections between the outer casing, the vacuum generator, and the sample bottle are quick disconnect connections.

9. The apparatus of claim 1, wherein the predetermined level is less than about 30 ml.

10. The apparatus of claim 9, wherein the sample tube and the vacuum tube are disposed within the sample container such that they do not come in direct contact with the liquid sample contained within the sample container.

11. The apparatus of claim 1, wherein the sample tube, the sample storage container, the vacuum tube, and the vacuum generator are made of a chemically inert material.

12. The apparatus of claim 11, wherein the chemical inert material comprises one of HDPE, PFA, FEP, and polyethylene.

13. An apparatus for obtaining a liquid material sample comprising:
a) a sample storage container;
b) a sample tube, wherein the sample tube defines a fluid path between a liquid material to be sampled and the sample storage container;
c) a vacuum tube;
d) a corrugated type flexible bottle having an internal volume, which is suitable for generating a partial vacuum, wherein:
1) the partial vacuum is generated by applying an external force to the bottle, which deforms the flexible bottle thereby reducing the internal volume, and then removing the external force which allows the flexible bottle to return to its original shape;
2) the vacuum tube defines a fluid path between the sample storage container and the flexible bottle; and
3) the partial vacuum generated by the flexible bottle is suitable for drawing part of the liquid material to be sampled through the sample tube and into the sample storage container, thereby filling the sample storage container with about 30 ml of the liquid material; and
e) an outer casing, wherein:
1) the outer casing is detachably connected to the flexible bottle and the sample storage container by threaded type connections; and
2) the outer casing encloses at least part of the sample tube.

14. The apparatus of claim 13, wherein the sample tube, the sample storage container, the vacuum tube, and the vacuum generator are made of a chemically inert material selected from one of HDPE, PFA, FEP, and polyethylene.

15. The apparatus of claim 14, wherein the internal volume of the flexible bottle, in its non-reduced state, is between about 100 ml and about 500 ml.

16. The apparatus of claim 15, wherein the sample tube and the vacuum tube are disposed within the sample container such that they do not come in direct contact with the liquid sample contained within the sample container.

17. A method of obtaining a sample of a liquid material, comprising:
a) providing a sampling device, wherein the sampling device comprises:
1) a sample storage container;
2) a sample tube, wherein the sample tube defines a fluid path between a liquid material to be sampled and the sample storage container;
3) a vacuum tube;
4) a flexible bottle, wherein the vacuum tube defines a fluid path between the sample storage container and the flexible bottle; and
5) an outer casing which comprises detachable connections to the flexible bottle and the sample bottle, and which encloses at least part of the sample tube;
b) applying a force to the flexible bottle which deforms the flexible bottle thereby decreasing its inner volume;
c) placing an end of the sample tube into the liquid material to be sampled;
d) removing the force from the flexible bottle, thereby allowing the bottle to return to its initial shape and generating a partial vacuum; and
e) drawing a sample, with the partial vacuum, through the sample tube and into the sample storage container, wherein the sample comprises less than about 30 ml of the liquid material.

18. The method of claim of claim 17, further comprising:
a) removing the end of the sample tube from the liquid material; and
b) detaching the sample container which contains the sample, from the outer casing, and capping the sample container.

19. The method of claim 18, further comprising:
a) transporting the capped sample container from the location where the sample was drawn to a second location; and
b) performing an analysis on the sample at the second location.

20. The method of claim 17, wherein the sample tube, the sample storage container, the vacuum tube, and the flexible bottle are made of a chemically inert material selected from one of HDPE, PFA, FEP, and polyethylene.
